(19) United States
(12) Patent Application Publication
(10) Pub. No.: US 2024/0399460 A1
(43) Pub. Date: Dec. 5, 2024

(54) TECHNIQUE FOR DEFINING A PLURALITY OF IRRADIATION VECTORS

(71) Applicant: Nikon SLM Solutions AG, Luebeck (DE)

(72) Inventors: Lorenz Kropholler, Luebeck (DE); Jiachun Chen, Luebeck (DE); Dieter Schwarze, Luebeck (DE)

(21) Appl. No.: 18/694,595

(22) PCT Filed: Oct. 24, 2022
(86) PCT No.: PCT/EP2022/079605

§ 371 Date: Mar. 22, 2024

(30) Foreign Application Priority Data
Oct. 22, 2021 (DE) 10 2021 127 580.6

(51) Int. Cl. B22F 10/36; B22F 10/28; B33Y 10/00; B33Y 30/00; B33Y 40/00

(52) U.S. Cl. CPC B22F 10/36; B22F 10/28; B33Y 10/00; B33Y 30/00; B33Y 40/00; B22F 2998/10

(57) ABSTRACT

A method for defining a plurality of irradiation vectors for an apparatus for producing a three-dimensional work piece via additive manufacturing is provided. The method comprises, for a layer of a three-dimensional work piece to be generated, defining a downskin region in the layer, and defining a set of first irradiation vectors covering the downskin region. At least one of the first irradiation vectors extends into a volume region of the layer, adjacent to the downskin region. The at least one of the first irradiation vectors has a length of 1 mm or more. The method further comprises defining a set of second irradiation vectors covering a remaining part of the volume region of the layer, assigning a first set of irradiation parameters to the set of first irradiation vectors, and assigning a second set of irradiation parameters to the set of second irradiation vectors, the second set of irradiation parameters being different from the first set.

The present invention generally relates to additive manufacturing. In particular, the present invention is directed to a technique for defining a plurality of irradiation vectors for an apparatus for producing a three-dimensional work piece via additive manufacturing. The apparatus for producing a three-dimensional work piece may be, without limitation, an apparatus for powder bed fusion, such as selective laser sintering and/or selective laser melting.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to radiation (e.g., laser or particle radiation) in a site-selective manner in dependence on the desired geometry of the work piece that is to be produced. The radiation penetrating into the powder layer causes heating and consequently melting or sintering of the raw material powder particles. Further raw material powder layers are then applied successively to the layer on the carrier that has already been subjected to radiation treatment, until the work piece has the desired shape and size. Powder bed fusion may be employed for the production of prototypes, tools, replacement parts, high value components or medical prostheses, such as, for example, dental or orthopedic prostheses, on the basis of CAD data. Examples for powder bed fusion techniques include selective laser melting and selective laser sintering.

Apparatuses are known for producing one or more work pieces according to the above technique. For example, EP 2 961 549 A1 and EP 2 878 402 A1, respectively, describe an apparatus for producing a three-dimensional work piece according to the technique of selective laser melting. The general principles described in these documents may also apply to the technique of the present disclosure.

With the additive manufacturing processes described above, it is possible to generate work pieces with various shapes and dimensions. For example, a work piece may comprise a surface facing downwards towards the carrier on which the three-dimensional work piece is built. This kind of surface of a work piece will also be referred to herein as a downskin surface. Downskin surfaces may exist at overhang regions of the work piece, at internal bores, and/or at inclined side surfaces of the work piece.

In the prior art, it is known to apply modified irradiation parameters for irradiation vectors of areas of layers of the work piece, which are part of a downskin surface. This may be necessary due to a lack of heat transfer in these areas, which may cause overheating and, increased internal stresses, and deformation of these areas.

In particular, it is known to reduce an irradiation power in downskin regions of a layer of the work piece. For the purpose of applying modified irradiation parameters, a hatching (i.e., definition of a position of the irradiation vectors) is carried out such, that the downskin region and the remaining region (in the following: volume region) are hatched separately and different irradiation parameters are applied to the vectors of the hatching of the downskin region and the vectors of the hatching of the volume region.

In other words, for building a low angle structure or a lattice structure, a very critical issue during the build process is the overheating and the resulting internal stress that causes a deformation of the solidifying layer and leads to wrap up if the geometry remains critical. For the low angle structure, the heat transfer at the overhanging area is much worse than over massive volume.

However, the above prior art technique may cause a situation that vectors of the downskin region and/or vectors of the remaining volume region are too short. Short vectors lead to too short cooling time between neighbored vectors. The resulting overheating may lead, e.g., to a problem of an unstable building process.

The invention is therefore directed at the object of providing a technique that solves at least one of the aforementioned problems and/or other related problems. In particular, and without limitation, a technique is provided, which avoids short vectors in the context of downskin region.

This object is addressed by a method, by a computer program product, as well as by a device according to the independent claims. Advantageous embodiments are indicated in the dependent claims.

According to a first aspect, a method for defining a plurality of irradiation vectors for an apparatus for producing a three-dimensional work piece via additive manufacturing is provided. The method comprises, for a layer of a three-dimensional work piece to be generated, defining a downskin region in the layer, and defining a set of first irradiation vectors covering the downskin region. At least one of the first irradiation vectors extends into a volume region of the layer, adjacent to the downskin region. The at least one of the first irradiation vectors has a length of 1 mm or more. The method further comprises defining a set of second irradiation vectors covering a remaining part of the volume region of the layer, assigning a first set of irradiation parameters to the set of first irradiation vectors, and assigning a second set of irradiation parameters to the set of second irradiation vectors. The second set of irradiation parameters is different from the first set.

The following description of the method aspects of the present disclosure also apply to the device aspects described below.

The method may be carried out by a device for generating an output file comprising instructions for the apparatus on how to carry out irradiation in order to generate the three-dimensional object, on the basis of an input file defining a geometry of the three-dimensional object to be generated. The device may be a personal computer running a software (computer program) that is configured to perform the method of the first aspect. Hence, the method may comprise loading an input file defining a geometry of the three-dimensional object to be generated and defining the layers of the three-dimensional object on the basis of the input file. This process may be referred to as slicing. Further, after the irradiation parameters are assigned, the method may comprise outputting an output file comprising instructions for the apparatus. The instructions may define a plurality of irradiation vectors for each layer of the work piece and one or more irradiation parameters assigned to these irradiation vectors.

The apparatus for producing the three-dimensional object via additive manufacturing may be an apparatus for powder bed fusion, such as selective laser melting or selective laser sintering, both of which are well-known techniques for the person skilled in the art and will only be described very briefly in the present disclosure.

In particular, the process carried out by the apparatus may involve depositing a first layer of raw material powder onto a carrier of the apparatus. The first layer (as well as the subsequent layers) may have a predefined layer thickness, wherein the layer thickness may be adjusted from layer to layer or may be fixed. The powder layers may be deposited by any suitable technique, wherein several methods and apparatuses for generating raw material powder layers are known in the art. After having deposited the first raw material powder layer, predefined regions of the powder are irradiated by a laser or electron beam, according to the output file generated by the method, the output file defining a work piece and/or a support structure to be produced. In this way, a first layer of a work piece to be generated may be irradiated and thereby solidified directly on the carrier or on a support structure bonded to the carrier or without direct nor indirect solid connection to the carrier. In a subsequent step, a second layer of raw material powder is deposited and predefined regions of said layer are irradiated and solidified. In this way, the work piece is generated layer by layer.

The method of the first aspect may be carried out for each layer of the work piece. The set of first vectors may fully cover the downskin region. This may mean that the set of first vectors is configured to solidify the entire downskin region. In other words, there is no section of the downskin region covered by irradiation vectors not belonging to the set of first vectors. Downskin contours may be taken into or left out from consideration. Contour vectors in the downskin region may be considered as first vectors or as other vectors exclusively or a mix of first and other vectors. It should be kept in mind, however, that the individual irradiation vectors of the first set (as well as the other irradiation vectors defined herein) have a predefined distance between each other (the hatch distance) and that small spaces may be left between the individual vectors both in a direction of extension of the vectors and perpendicular to this direction of extension. These small spaces are, however, solidified due to an extension of the generated melt pool. Similarly, small spaces may be left with regard to one or more contour vectors of the work piece defining a contour to be irradiated.

The at least one of the first irradiation vectors extending into the volume region of the layer may extend over a border line between the downskin region and the volume region. The at least one of the first irradiation vectors has a length of 1 mm or more. This may mean that a minimum length of 1 mm has been set for the at least one of the first irradiation vectors. The at least one of the first irradiation vectors may have a length of 1.5 mm or more, 2 mm or more, 3 mm or more, or 4 mm or more. The volume region of the layer may be defined as the remaining part of the layer, not being the downskin region.

The steps of assigning irradiation parameters to the respective sets of irradiation vectors may mean that instructions are generated, instructing the apparatus to irradiate the set of first irradiation vectors with the first set of irradiation parameters and to irradiate the set of second irradiation vectors with the second set of irradiation parameters.

The fact that the second set of irradiation parameters is different from the first set may mean that at least one irradiation parameter (e.g., laser power) of the second set differs from a corresponding one of the first set. For example, a laser power assigned to the first irradiation vectors may be different from a laser power assigned to the second irradiation vectors.

Each of the first irradiation vectors may have at least a length of 15 mm, 10 mm, 8 mm, 5 mm, 4 mm, 3 mm, 2 mm, or 1 mm. In other words, a lower limit may be defined for a length of each first irradiation vector defined in the step of defining the set of first irradiation vectors. This lower limit is also referred to herein as first predefined length. The first predefined length may be suitably selected and it may be one of 15 mm, 10 mm, 8 mm, 5 mm, 4 mm, 3 mm, 2 mm, or 1 mm.

Each of the second irradiation vectors may have at least a length of 15 mm, 10 mm, 8 mm, 5 mm, 4 mm, 3 mm, 2 mm, or 1 mm. In other words, a lower limit may be defined for a length of each second irradiation vector defined in the step of defining the set of second irradiation vectors. This lower limit is also referred to herein as second predefined length. The second predefined length may be suitably selected and it may be one of 15 mm, 10 mm, 8 mm, 5 mm, 4 mm, 3 mm, 2 mm, or 1 mm.

Setting a lower limit for a length of a first irradiation vector and/or of a second irradiation vector may have an advantage that the respective irradiation vector can be reliably irradiated under stable irradiation conditions. Further, short irradiation vectors may lead to too short cooling time between neighbored vectors. The resulting overheating may lead, e.g., to a problem of an unstable building process.

The downskin region may be defined as a region of the layer in which fewer than a predefined number of work piece layers are provided between the layer and an underlying layer of unsolidified raw material powder. The volume region may be defined as a region of the layer in which at least the predefined number of work piece layers are provided between the layer and the underlying layer of unsolidified raw material powder or in which no underlying layer of unsolidified raw material powder exists.

When defining downskin region and/or volume region, support structures may be considered as solidified raw material. Since support structures typically are small, the support structures may alternatively be considered as unsolidified raw material powder for the purpose of defining downskin regions and/or volume regions.

The predefined number of work piece layers may be one or more than one. In case the predefined number is one, the downskin region is defined as a region of the layer of the work piece directly contacting the underlying layer of unsolidified raw material powder and thus building at least part of a downskin surface of the work piece. In case the predefined number is more than one, at least one intermediate work piece layer may be provided between the respective downskin region and the underlying unsolidified raw material powder. The above definition of the downskin region is considered in a projection along the z-axis, i.e., along an axis perpendicular to the layers of the work piece. This means that positions of borders of the downskin region (i.e., within the layer and, therefore, within an x-y-plane) correspond to positions of borders of the unsolidified powder, with regard to the x-y-plane. The definition of the volume region may be such that it contains a remaining part of the layer of the work piece, apart from the downskin region.

The set of irradiation parameters may comprise at least one of laser power, laser wavelength, scanning speed, scanning mode, laser spot size, laser spot shape, laser operation mode, hatch distance, and jump time between vectors. Exemplary scanning modes may be e.g. continuous, stepwise or oscillating movement. Exemplary laser spot shapes may be circular, rectangular or donut shaped laser spots. Exemplary laser operation modes may be continuous wave, quasi continuous wave, long pulsed, short pulsed, single pulse, repetitive pulse, or burst mode.

The method may further comprise defining one or more first initial vector(s) in the downskin region and deciding, for each of the one or more first initial vector(s), whether the respective first initial irradiation vector has a length smaller than a first predefined length. The method may further comprise the step of, for each of the one or more first initial vector(s), if it is decided that the first initial vector has a length smaller than the first predefined length, extending the first initial vector, such that it extends into the volume region, to form a first extended irradiation vector. The at least one of the first irradiation vectors may comprise the first extended irradiation vector.

Hence, at least one initial vector is generated, which is subsequently “optimized” to meet a length requirement, i.e., to have at least a first predefined length.

The method may further comprise defining a hatch pattern of initial vectors for the downskin region and for the volume region. The downskin region is covered by a set of first initial vectors and the volume region is covered by a set of second initial vectors. The method may further comprise deciding, for a plurality of the first initial vectors, whether the respective first initial vector has a length smaller than a first predefined length, and for each of the plurality of first initial vectors, if it is decided that the first initial vector has a length smaller than the first predefined length, extending the first initial vector, such that it extends into the volume region, to form a first extended irradiation vector, wherein the at least one of the first irradiation vectors comprises the first extended irradiation vector.

Hence, a plurality of initial vectors is generated, wherein these initial vectors are subsequently “optimized” to meet a length requirement, i.e., to have at least a first predefined length.

An initial vector, in the context of the present disclosure, may be a vector that is defined by the method (during the process of the method) but which is not necessary identical to a final irradiation vector (i.e. part of the set of first irradiation vectors or the set of second irradiation vectors). Thus the initial vector may be regarded as direction and spatial extension information or rather as a mathematical element. However, the initial vector may indeed correspond to a final irradiation vector. The initial vector(s) may be regarded as being part of an initial hatching pattern, which would be used, e.g., as a hatching pattern of irradiation vectors of a prior art device. However, this initial hatching pattern is optimized by the technique of the present disclosure, in particular to avoid too short irradiation vectors.

Due to the fact that a vector scanning direction may be changed after vector generation (hatching) or only be assigned after completion of vector generation, the term “vector” in the context of the present disclosure should be understood as a planned irradiation path, not necessarily comprising information on direction. An information regarding location and dimensions of a planned irradiation path should be considered as “vector” in the terms of the present disclosure. In other words, the expression “irradiation vector” could be replaced with “irradiation path” or “irradiation line”, in the entire present disclosure. However, of course, an “irradiation vector” according to the present disclosure may indeed comprise information on direction, according to some embodiments. The term “initial vector” may therefore be understood as an “intermediate irradiation path” used for a logical definition during the process of generating the final irradiation vectors. For example, the initial vectors may undergo further merging, expansion, redirection, and/or shortening steps before they become final irradiation vectors. The “initial vectors” disclosed herein may be, in particular, referred to as “initial irradiation vectors”.

In the state of the art, sometimes vectors are assigned and provided with additional information for changing irradiation parameters during scanning the irradiation beam along the vector. In the context of the present disclosure, such vectors with parameter switching points may be considered as separate vectors with different parameters, cut at the switching point.

The downskin region may be fully covered by the set of first initial vectors and the volume region may be fully covered by the set of second initial vectors. For example, the downskin region may be covered by the set of first initial vectors such that the entire downskin region (apart from a possible contour) would be solidified by the set of first initial vectors. The volume region may be covered by the set of second initial vectors such that the entire volume region (apart from a possible contour) would be solidified by the set of second initial vectors.

The first predefined length may be, e.g., 15 mm, 10 mm, 8 mm, 5 mm, 4 mm, 3 mm, 2 mm, or 1 mm. The first predefined length may be set on the basis of the used raw material powder material, on the basis of the used layer thickness, the irradiation parameters applied and/or on the basis of a used irradiation system. In the context of the invention such predefinition may be performed either directly or indirectly in view of the irradiation parameters applied, in particular the scanning speed, from which a resulting irradiation vector length can be derived.

For example, the at least one of the first irradiation vectors may correspond to the first extended irradiation vector. Extending the first initial vector (and, in general, extending a vector as used herein) may mean that the vector maintains its direction but is extended (i.e., made longer), either at a beginning side or end side of the respective vector.

At least one of the second initial vectors in a region adjacent to the downskin region may have an orientation different from an orientation of the first extended irradiation vector. The at least one of the second initial vectors may be at least partially discarded. A discarded part of said second initial vector may be replaced by the first extended irradiation vector.

The orientation of the at least one of the second initial vector may be perpendicular to the orientation of the first extended irradiation vector. For example, the second initial vectors may be arranged in a so-called checkerboard pattern, wherein in each tile (e.g., square tile), parallel vectors are arranged and an orientation of the vectors changes from tile to tile by 90°. In other words, at least sections of some of the second initial vectors are replaced by the first extended irradiation vector having a different orientation than an orientation of the replaced sections.

Further, at least two second initial vectors in a region adjacent to the downskin region may have a hatch distance different from a hatch distance of at least two first irradiation vectors or first initial vectors in the downskin region. In this case, the at least two first irradiation vectors or first initial vectors may be extended into the volume region and thereby, a hatch pattern in the volume region may be adapted to the hatch pattern of the first irradiation vectors or the first initial vectors.

The step of extending may comprise merging the first initial vector with one or two adjacent second initial vector(s) to form the first extended irradiation vector.

Merging, however, does not necessarily mean that the entire one or two adjacent second initial vector(s) are added to the first initial vector. Merging may also mean that only at least a section of the one or two adjacent second initial vector(s) are added (or “merged”). In case one adjacent second initial vector is merged, this means that the first initial vector is extended to one side. In case two adjacent second initial vectors are merged, this means that the first initial vector is extended to two (both) sides (i.e., at a beginning side and an end side of the vector).

In general, according to the present disclosure, “merging” a first vector with a second vector refers to a situation, where a first vector and a second vector are located next to each other (adjacent) and on a same line. A gap may be provided between the first vector and the second vector. Merging means a) that the first vector is extended into a direction of the second vector, such that the resulting (“merged” or “extended” vector) comprises the first vector and at least a part of the second vector, or b) that the second vector is extended into a direction of the first vector, such that the resulting (“merged” or “extended” vector) comprises the second vector and at least a part of the first vector. However, according to the present disclosure, merging does not necessarily mean that the resulting vector always comprises the entire first and second vectors. However, in case it is mentioned that “an entire vector” is merged to another vector or that a vector is merged to “an entire vector”, this means that the entire vector and the another vector are comprised by the resulting vector.

It is further noted that the two or more merged vectors are not necessarily on a same line. For example, downskin vectors of a downskin region may be merged with volume vectors of a volume region, wherein a distance (hatch distance) between the downskin vectors is different from a distance (hatch distance) of the volume vectors. In this case, for example, the hatch distance of the downskin vectors may be aligned to the hatch distance of the volume vectors or vice versa. In other words, for example, two or more downskin vectors may be extended into the volume region, wherein a hatch distance of the two or more volume vectors is maintained in the volume region, even in the case that, before the extension, a hatch distance of volume vectors in the volume region was different than the hatch distance of the two or more downskin vectors.

The first extended irradiation vector may have the first predefined length.

In the step of merging, the first initial vector may be merged with two adjacent second initial vectors, such that a merged section of a first one of the adjacent second initial vectors has a same length as a merged section of a second one of the adjacent second initial vectors.

In other words, the merging (or extension) may be carried out to both sides equally (i.e., by an equal length). Again, according to the entire present disclosure, merging has to be understood as “extending a first vector by adding at least a section of a second vector” and not as “extending a first vector by adding the entire second vector”.

Additionally or alternatively, a first initial vector may be merged with two adjacent second initial vectors, such that a first one of the adjacent second initial vectors is entirely merged to the first initial vector and a second one of the adjacent second initial vectors is only partially merged to the first initial vector. This is advantageous, if the first one of the adjacent second initial vectors is shorter than a second predefined length and/or if a remaining section of the first one of the adjacent second initial vectors would be shorter than a second predefined length and/or if the first one of the adjacent second initial vectors is adjacent to a contour on its other end. In other words, an entire adjacent second initial vector may be merged with the first initial vector, in particular the second initial vector being adjacent to a contour vector on its other end before merging.

The method may further comprise, before, during, or in particular after the step of merging, deciding whether a remaining portion of at least one of the one or two adjacent second initial vector(s) is smaller than a second predefined length, and if it is decided that the remaining portion is smaller than the second predefined length, merging the first merged irradiation vector with the remaining portion to form a second extended irradiation vector, wherein the at least one of the first irradiation vectors comprises the second extended irradiation vector. Optionally, the second extended vector may be shortened at its end, where the remaining portion has not been added. In particular, this shortening may be carried out such that a resulting vector has a predefined length, e.g., the first predefined length or the second predefined length.

The second predefined length may correspond to or differ from the first predefined length. In other words, e.g. after the process has taken care that no too short first irradiation vectors of the downskin region exist, the process takes care that no too short second irradiation vectors of the volume region remain. Due to overheating, e.g., too short vectors may be a problem both in the downskin region and in the volume region. The first predefined length may be longer than the second predefined length. Alternatively the first predefined length may be shorter or the same as the second predefined length.

The method may further comprise identifying, in particular remaining, second initial vectors having a length smaller than the second predefined length, and merging the identified second initial vectors to adjacent first initial vectors or adjacent first or second extended irradiation vectors to form a first irradiation vector.

This step may be regarded as “collecting”, in particular remaining, second irradiation vectors that are too short and merging these vectors to adjacent vectors, if possible.

The method may further comprise defining a set of first initial vectors, wherein a plurality of the first initial vectors are extending into a volume region of the layer and have a same first predefined length, each of the plurality of first irradiation vectors comprising a corresponding first initial vector, and before, during, or in particular after the step of defining the set of first initial vectors, defining a set of second initial vectors, wherein at least some of the second irradiation vectors correspond to a corresponding second initial vector.

The set of first initial vectors may be oriented parallel with regard to each other and/or the set of second initial vectors may be oriented parallel with regard to each other. According to the aforementioned option, the hatching of vectors may already begin with first irradiation vectors that are not too short but rather which have the first predefined length (i.e., a sufficient length). The remaining second irradiation vectors in the volume region may be arranged “around” the first vectors, in a subsequent step or simultaneously.

The method may comprise identifying a workpiece contour in a distance to a border of a downskin region smaller than a second predefined length and defining a first initial vector extending to the workpiece contour. The first initial vector may be one of the set of first initial vectors.

The method may further comprise identifying, in particular remaining, second initial vectors having a length smaller than a second predefined length, and merging the identified, in particular remaining, second initial vectors to adjacent first initial vectors to form a first irradiation vector.

According to this step, it is taken care that also no too short second vectors (i.e., vectors of the volume region) remain if it can be prevented.

The method may further comprise determining an orientation of the set of first irradiation vectors within the layer, such that an amount of sections of the first irradiation vectors is minimized, wherein the sections are defined as being within the downskin region and having a length smaller than a first predefined length.

According to the aforementioned option, the orientation of the first irradiation vectors may be freely chosen and it is ideally chosen, with the goal of minimizing a number of first irradiation vectors that have to be extended in order to have a minimum predefined length.

The method may further comprise determining an orientation of the set of first initial vectors within the layer, such that an amount of sections of the first initial vectors is minimized, wherein the sections are defined as being within the downskin region and having a length smaller than a first predefined length.

Hence, also the initial vectors may be optimized with regard to their orientation. In particular, an orientation of initial vectors may be chosen, which minimizes a number of first initial vectors that have to be extended in order to have at least a minimum predefined length.

The method may further comprise irradiating the layer of the three-dimensional work piece according to the defined set of first irradiation vectors and the defined set of second irradiation vectors.

This step is carried out by the apparatus. In this regard, the apparatus may comprise the device. Alternatively, the corresponding method is directed to a system comprising the device and the apparatus. The method may further comprise additional typical steps of additive manufacturing, such as applying a layer of raw material powder, irradiating predefined portions, applying a further layer of raw material powder, irradiating predefined portions of the further layer, and so on.

According to a second aspect, a computer program product is provided, comprising program code portions for performing the method of the first aspect when the computer program product is executed on one or more computing devices.

The computer program product may be configured to read an input file defining a geometry of the work piece to be generated and to output an output file comprising instructions for the apparatus.

The computer program product may be stored on a computer-readable recording medium. The recording medium may be, e.g., a solid state recording medium, an optical recording medium, or a magnetic recording medium.

According to a third aspect, a device for defining a plurality of irradiation vectors for an apparatus for producing a three-dimensional work piece via additive manufacturing is provided. The device is configured to, for a layer of a three-dimensional work piece to be generated, define a downskin region in the layer, and define a set of first irradiation vectors covering the downskin region. At least one of the first irradiation vectors extends into a volume region of the layer, adjacent to the downskin region. The at least one of the first irradiation vectors has a length of 1 mm or more. The device is further configured to define a set of second irradiation vectors covering a remaining part of the volume region of the layer, assign a first set of irradiation parameters to the set of first irradiation vectors, and assign a second set of irradiation parameters to the set of second irradiation vectors, the second set of irradiation parameters being different from the first set.

The device of the third aspect may further be configured to carry out the steps of any of the methods defined under the first aspect.

Further, each of the details discussed above with regard to the first aspect (method), may apply also to the third aspect (device).

Beside the vectors covering the downskin region, the contour vectors in the downskin region may be treated in a similar manner. One or more downskin contour vectors may be extended into a volume contour region and considered as first irradiation vectors. In a special embodiment all contour vectors may be considered as first irradiation vectors.

In another embodiment contour vectors in the downskin region may be treated as not belonging to the downskin region, in particular all contour vectors may be considered as second irradiation vectors. When treating all contour vectors as first irradiation vectors, or treating all contour vectors as second irradiation vectors, different appearances on the workpiece surface may be prevented. In other words, a more homogeneous appearance and/or better work piece quality in the region of the contour can be achieved.

It is further noted that, in general, different irradiation parameters may be assigned to contour vectors and to hatch vectors. Irradiation parameters are, e.g., those indicated above. For example, one or more irradiation parameter of a first irradiation vector that forms a contour vector may be different from one or more irradiation parameter of a first irradiation vector that does not form a contour, i.e., that is not a contour vector. Similarly, one or more irradiation parameter of a second irradiation vector that forms a contour vector may be different from one or more irradiation parameter of a second irradiation vector that does not form a contour, i.e., that is not a contour vector.

Preferred embodiments of the invention are described in greater detail with reference to the appended schematic drawings, wherein

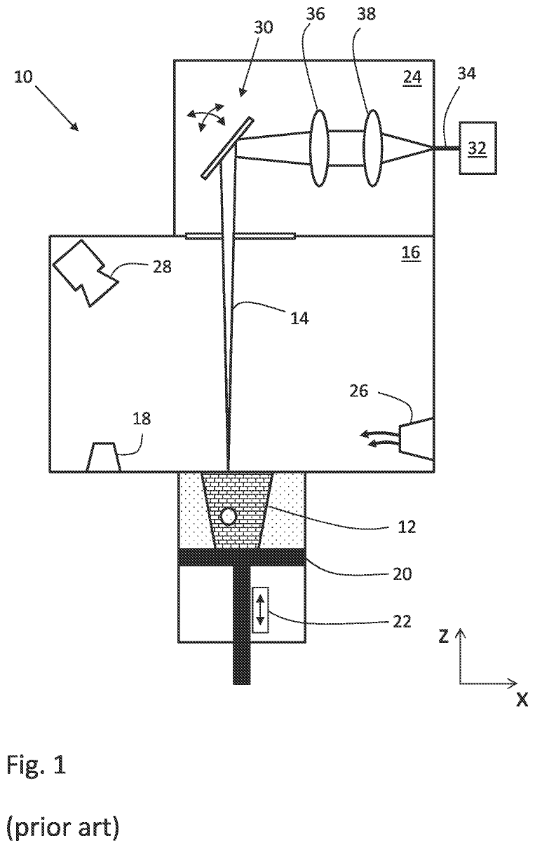

FIG. 1 shows a schematic representation of a known apparatus for producing a three-dimensional work piece via additive manufacturing;

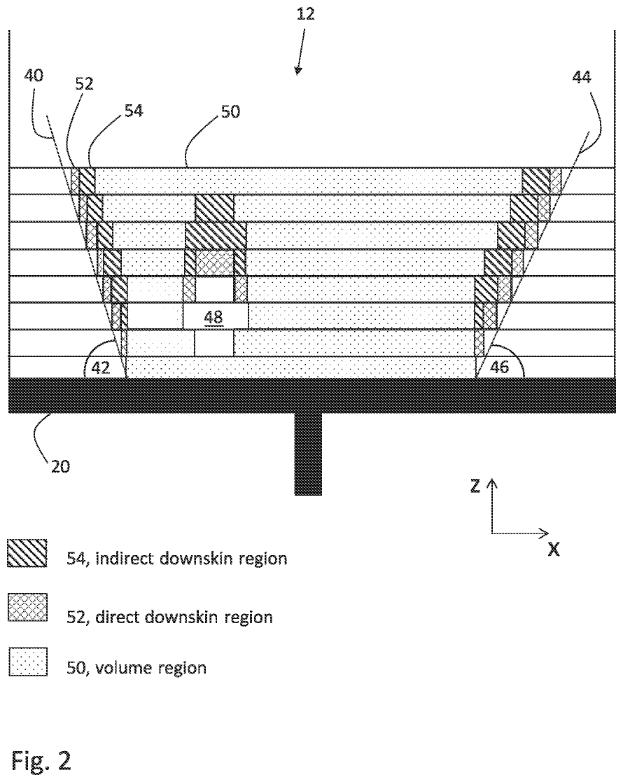

FIG. 2 shows a three-dimensional object generated by the apparatus of FIG. 1, wherein downskin regions and volume regions are defined in the individual layers of the work piece;

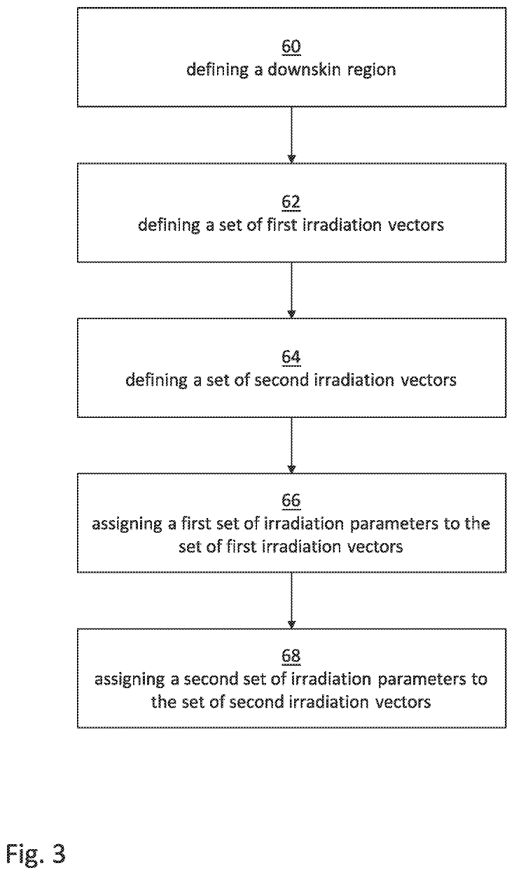

FIG. 3 shows a flow chart of a method for defining a plurality of irradiation vectors according to the present disclosure;

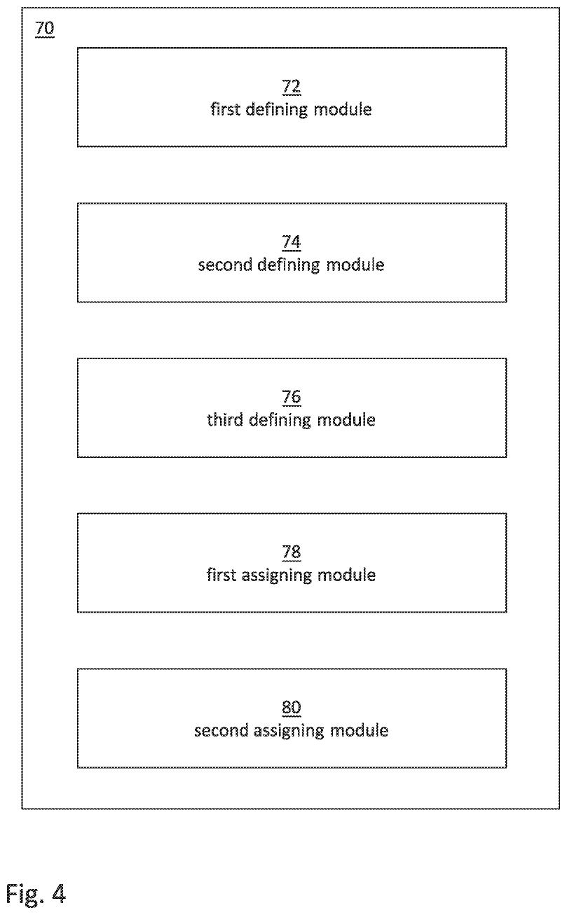

FIG. 4 shows a schematic representation of a device for defining a plurality of irradiation vectors according to the present disclosure;

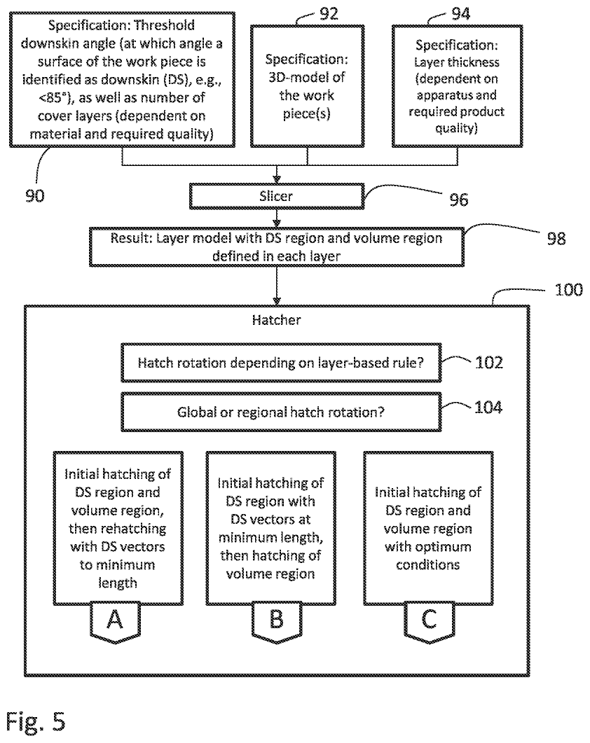

FIG. 5 shows a diagram including different embodiments how to define a plurality of irradiation vectors according to the present disclosure;

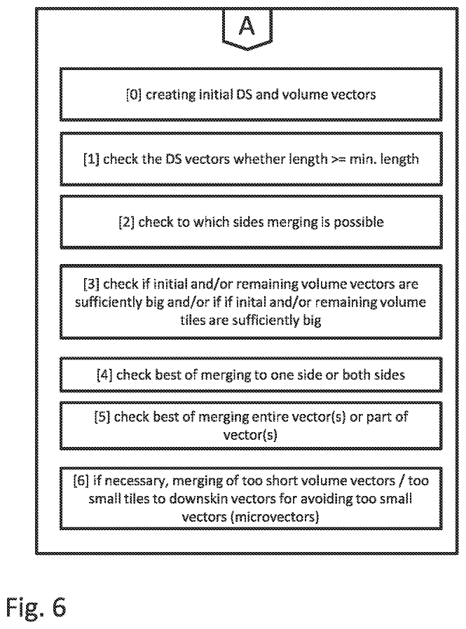

FIG. 6 shows a chart of the process “A” indicated in FIG. 5;

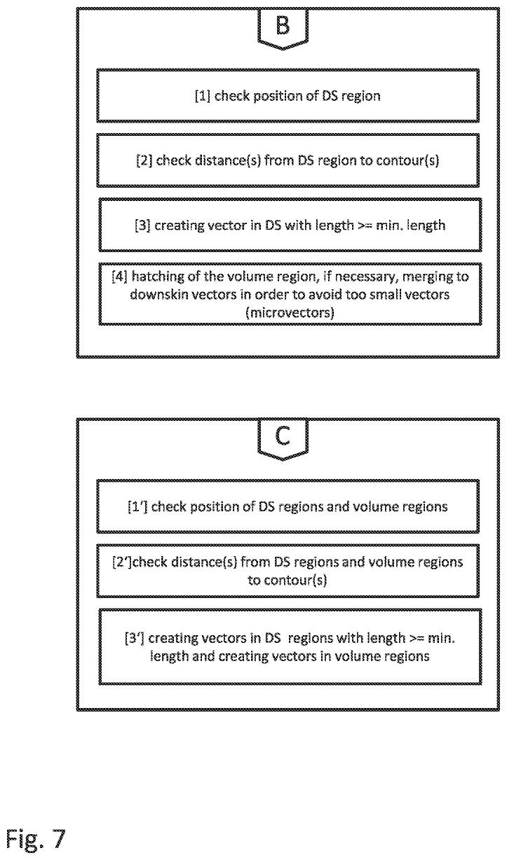

FIG. 7 shows charts of the processes “B” and “C” indicated in FIG. 5;

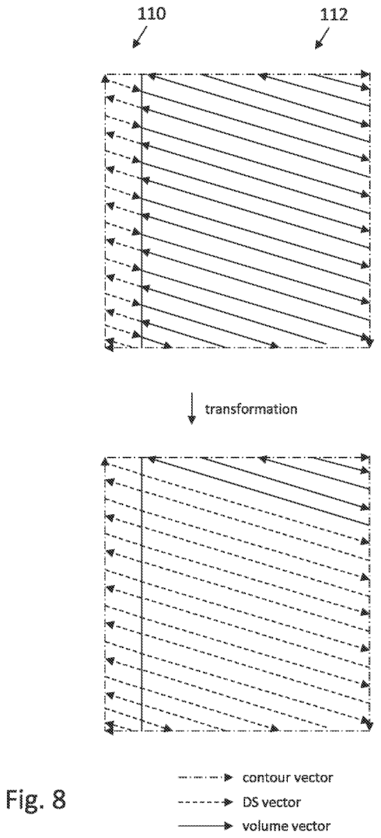

FIG. 8 shows how a method according to an embodiment of the present disclosure is applied to an exemplary work piece layer having a downskin region in an edge region of the layer;

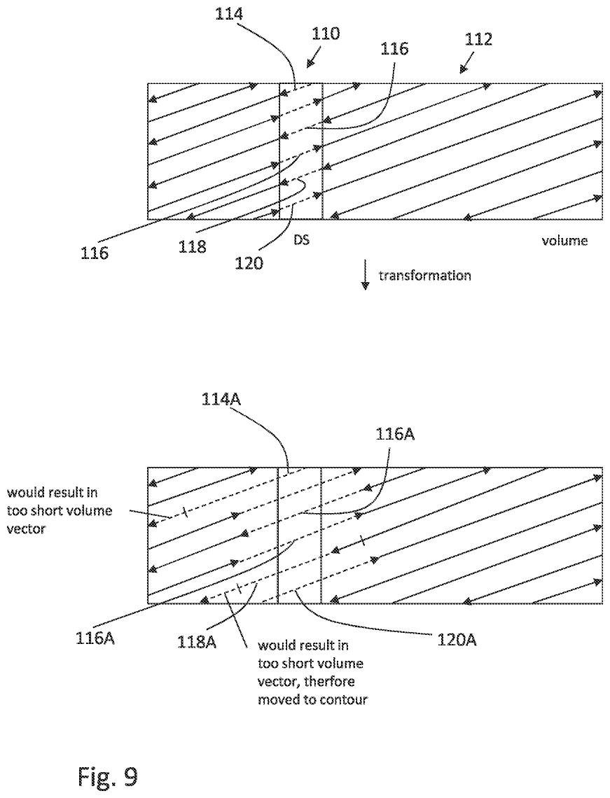

FIG. 9 shows how a method according to an embodiment of the present disclosure is applied to an exemplary work piece layer having a downskin region in an inner region of the layer, in the form of a stripe;

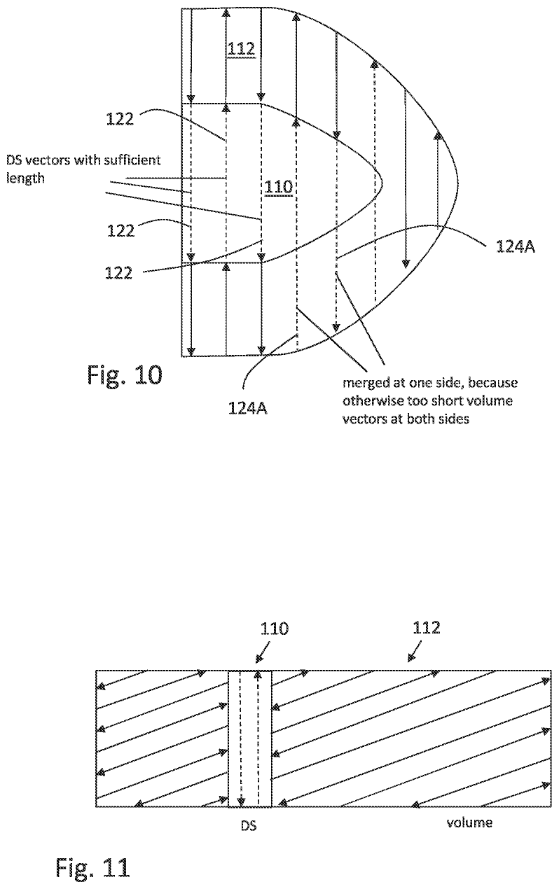

FIG. 10 shows another example, how a method according to an embodiment of the present disclosure is applied to an exemplary work piece layer having a downskin region; and

FIG. 11 shows another example, how a method according to an embodiment of the present disclosure is applied to an exemplary work piece layer having an inner region of the layer, in the form of a stripe, wherein an optimal direction of the downskin vectors is chosen.

FIG. 1 shows a schematic representation of an apparatus 10 for producing a three-dimensional work piece 12. The apparatus may be an apparatus, to which a file is transferred that is generated with a method and/or device according to the present disclosure. In other words, the present disclosure describes a technique for defining a plurality of irradiation vectors. For example, a file is generated comprising the definition of the irradiation vectors. This file may be used by the apparatus 10 of FIG. 1 in order to produce a three-dimensional work piece 12 according to the instructions stored in the file. In still other words, the apparatus 10 irradiates the irradiation vectors that are defined according to the technique described herein.

The principles of the apparatus 10 are well-known to the person skilled in the art in the field of additive manufacturing and will only be described briefly. For example, such an apparatus 10 may be an apparatus for selective laser melting or an apparatus for selective laser sintering, wherein one or more laser beams 14 may be used for selectively irradiating and solidifying subsequent layers of raw material powder.

The apparatus 10 for carrying out a process of selective laser melting as described below may serve as an example. Typical features of powder bed fusion are that a raw material powder is applied in layers and each layer is selectively irradiated and solidified in order to generate one layer of a work piece 12 to be produced. After removing excess powder, and after optional steps of post processing (e.g., removing one or more support structures), the final work piece 12 is obtained.

FIG. 1 shows an apparatus 10 for producing a three-dimensional work piece 12 by selective laser melting. The apparatus 10 comprises a process chamber 16. The process chamber 16 is sealable against the ambient atmosphere, i.e. against the environment surrounding the process chamber 16. A powder application device 18, which is arranged in the process chamber 16, serves to apply a raw material powder onto a carrier 20. A vertical movement unit 22 is provided, such that the carrier 20 can be displaced in a vertical direction so that, with increasing construction height of the work piece 12, as it is built up in layers from the raw material powder on the carrier 20, the carrier 20 can be moved downwards in the vertical direction.

Since the movability of the carrier 20 by means of the vertical movement unit 22 is well known in the field of selective laser melting, it will not be explained in detail herein. As an alternative to the movable carrier 20, the carrier 20 may be provided as stationary (or fixed) carrier (in particular, with regard to the vertical z-direction), wherein the irradiation unit 24 (see below) and the process chamber 16 are configured to be moved upwards during the build process (i.e., with increasing construction height of the work piece 12). Further, both the carrier 20 and the irradiation unit 24 may be individually movable along the z-direction.

A carrier surface of the carrier 16 defines a horizontal plane (an x-y-plane), wherein a direction perpendicular to said plane is defined as a vertical direction or build direction (z-direction). Hence, each uppermost layer of raw material powder and each layer of the work piece 12 extend in a plane parallel to the horizontal plane (x-y-plane) defined above.

The apparatus 10 further comprises a gas inlet 26 for supplying an inert gas (e.g., argon) into the process chamber 16. A gas outlet (not shown) may be provided, such that a continuous stream of gas may be generated through the process chamber 16 by implementing a gas circuit. In a preferred embodiment a unidirectional laminar flow is generated over the uppermost raw material powder layer.

Further, a camera 28 is arranged in the process chamber 16, for observing the laser beam 14 directed by the optical unit 24 towards the powder bed during operation and/or for observing irradiated regions after irradiation by the laser beam 14. Further, by blocking a wavelength of the laser beam 14 with a respective optical filter, only the heat radiation of a generated melt pool may be observed. The camera 28 may be part of a melt pool observation device.

The apparatus 10 further comprises an optical unit 24 (also referred to as irradiation unit) for selectively irradiating the laser beam 14 onto the uppermost layer of raw material powder applied onto the carrier 20. By means of the optical unit 24, the raw material powder applied onto the carrier 20 may be subjected to laser radiation in a site-selective manner in dependence on the desired geometry of the work piece 12 that is to be produced.

The optical unit 24 comprises a scanning unit 30 configured to selectively irradiate the laser beam 14 onto the raw material powder applied onto the carrier 20. The scanning unit 30 is controlled by a control unit (not shown) of the apparatus 10. The scanning unit 30 may comprise one mirror tiltable with regard to two perpendicular axes. Alternatively, the scanning unit 30 may comprise two tiltable mirrors, each configured to be tilted with regard to a corresponding axis. The tiltable mirrors may be, e.g., galvanometer mirrors.

The optical unit 24 is supplied with laser radiation from a laser beam source 32. The laser beam source 32 may be provided within the optical unit 24 or outside the optical unit 24, as shown in FIG. 1. In the latter case, the laser beam is generated by the laser beam source 32 and guided into the optical unit 24 via an optical fiber 34. Alternatively, the laser beam may be guided into the optical unit 24 through the air or through a vacuum, e.g., by using one or more mirrors.

From the laser beam source 32, the laser beam is directed to the scanning unit 30. The laser beam source 32 may, for example, comprise a diode pumped Ytterbium fiber laser emitting laser light at a wavelength of approximately 1070 to 1080 nm.

The optical unit 24 further comprises two lenses 36 and 38, which are configured to focus the laser beam 14 onto a desired focus position along the z-axis. In the embodiment shown in FIG. 1, both lenses 36 and 38 have positive refractive power. The lens 38 further upstream of the beam path is configured to collimate the laser light emitted by the fiber 34, such that a collimated or substantially collimated laser beam is generated. The lens 36 further downstream of the beam path is configured to focus the collimated (or substantially collimated) laser beam onto a desired z-position.

FIG. 2 shows a schematic figure of an exemplary work piece 12, in which a plurality of downskin regions are defined. The work piece 12 may be, e.g., the work piece 12 generated by the apparatus 10 shown in FIG. 1. While the work piece 12 shown in FIG. 1 has smooth side surfaces, the representation of FIG. 2 is more realistic in this regard, showing a step-like structure at the side surfaces of the work piece 12. Every layer of the work piece has predefined dimensions within the x-y-plane, wherein a smoothness of the side surface can be controlled, e.g., by changing a layer thickness of the individual layers.

As shown in FIG. 2, the exemplary work piece 12 has a first inclined side surface 40 forming an angle 42 with regard to the carrier 20 (and, therefore, with regard to the x-y-plane). The work piece 12 further has a second inclined side surface 44 forming an angle 46 with regard to the carrier 20. Further, a bore 48 is provided in a central region of the work piece 12. The inclined side surfaces 40 and 44 are approximated by dashed lines, wherein the real step-wise shape of the surfaces 40, 44 is also shown in FIG. 2

With regard to the inclined surfaces 40 and 44, a threshold downskin angle may be considered, for example 85°, with regard to the x-y-plane, i.e., with regard to a surface of the carrier 20. Only in case the angle 42, 46 of the respective inclined surface 40, 44 is below said threshold downskin angle, downskin regions may be defined with regard to the respective inclined surface. In other words, if the surface forms an angle of 90° or close to 90° with regard to the x-y-plane (i.e., with regard to a plane in which the layers of the work piece 12 extend), the surface may not be regarded as downskin surface and no downskin regions may be defined with regard to this surface.

However, in the case shown in FIG. 2, the angles 42 and 46 of both inclined surfaces 40 and 44 are small enough (i.e., smaller than the threshold downskin angle), such that downskin regions are defined with regard to these surfaces 40, 44.

Similar to the definition of a threshold angle, a threshold length may be defined. In this case, each of the potential downskin surfaces is checked whether an extension of the potential downskin surface in all directions within the x-y-plane is larger than the predefined length. Only in this case, the potential downskin surface is considered for definition of a downskin region, otherwise not.

Downskin regions of the respective layers of the work piece 12 are indicated by a grid filling or by a striped filling. The regions 52 indicated by the grid filling represent direct downskin regions, whereas the regions 54 indicated by the striped filling indicate indirect downskin regions. Both type of regions will be referred to as downskin regions in the following and both regions are treated as downskin regions of the respective layer. Remaining regions of the respective layers are defined as volume regions 50. The direct downskin regions 52 form part of a downskin surface of the work piece 12.

A direct downskin region 52 is a region of a specific layer of the work piece 12, which is provided directly over an underlying layer of unsolidified raw material powder (white regions besides the layers of the work piece in FIG. 2). Indirect downskin regions 52 may additionally be defined. In particular, a downskin region may be defined as a region of a layer of the work piece 12 in which fewer than a predefined number of work piece layers are provided between the layer and an underlying layer of unsolidified raw material powder. In the example shown in FIG. 2, the predefined number is 3. In other words, besides the direct downskin region 52, indirect downskin regions 54 exist in the following two layers above the direct downskin region 52. Further, the remaining part of each layer of the work piece 12 is defined as a volume region 50. In other words, the volume region 50 is defined as a region of the layer in which at least the predefined number (in the case of FIG. 2:3) of work piece layers are provided between the layer and the underlying layer of unsolidified raw material powder or in which no underlying layer of unsolidified raw material powder exists.

Beside downskin regions and volume regions, further regions may be defined in layers of the workpiece, such as upskin regions or support contacting regions. Definitions of regions, however, may be overlapping and/or dependent on which types of regions are applied.

Generally speaking, downskin regions 52, 54 are regions in which at least one different irradiation parameter is applied as compared to the volume regions 50. For example, a laser power irradiated to the downskin regions 52, 54 may be lower than a laser power irradiated to the volume regions 50. The reason for applying a reduced laser power in the direct downskin regions 52 is, that heat transfer to the underlying raw material powder is reduced, which may lead to overheating. Similarly, this effect may also present in layers directly above the direct downskin regions 52, such that it may be advantageous to also apply different irradiation parameters in the indirect downskin regions 54.

As shown in FIG. 2, downskin regions 52, 54 may exist at edges of a layer (i.e., in direct contact to a contour of the layer) or in the form of internal downskin regions 52, 54 at an inner part of the layer, i.e., not adjacent to an edge of the layer.

In the following, it will be discussed, how the downskin regions 52, 54 may be treated differently from the volume regions 50, according to embodiments of the present disclosure. In particular, for all the methods described in the following, downskin vectors and volume vectors are defined. It is common to the methods described herein, that a first set of irradiation parameters is assigned to the downskin vectors, wherein a second, different set of irradiation parameters is assigned to the volume vectors. For example, a laser power assigned to the downskin vectors may be different from a laser power assigned to the volume vectors.

It is further noted that the process of assigning downskin vectors and volume vectors is carried out after a slicing process performed by a slicer (e.g., a logical unit or software unit). The slicer considers the geometrical data of the work piece 12 to be generated, e.g., by reading a corresponding input CAD file. Based on the geometrical data, an orientation of the work piece 12 with regard to the carrier 20 may be decided and individual layers of the work piece 12 are defined. A layer thickness of the individual layers may vary.

These individual layers form the input of the following processes.

FIG. 3 shows a flow chart of a method for defining a plurality of irradiation vectors according to the present disclosure.

The method is carried out for a layer of a three-dimensional work piece 12 to be generated and may be repeated for each layer of the work piece 12.

The method starts with a step 60 of defining a downskin region 52, 54 in the layer. The downskin region 52, 54 may be defined according to the criteria discussed above with regard to FIG. 2.

In a step 62, a set of first irradiation vectors fully covering the downskin region 52, 54 is defined. At least one of the first irradiation vectors extends into a volume region 50 of the layer, adjacent to the downskin region 52, 54. The at least one of the first irradiation vectors have a length of 1 mm or more.

In a step 64, a set of second irradiation vectors is defined, covering a remaining part of the volume region 50 of the layer.

In a step 66, a first set of irradiation parameters is assigned to the set of first irradiation vectors.

In a step 68, a second set of irradiation parameters is assigned to the set of second irradiation vectors, the second set of irradiation parameters being different from the first set.

An output of the method shown in FIG. 3 may be a file comprising instructions for an apparatus 10 for generating a three-dimensional work piece (e.g., the apparatus 10 shown in FIG. 1) on how to carry out the built of the work piece 12 (in particular, how to carry out the irradiation of the individual layers).

FIG. 4 shows a schematic representation of a device 70 for defining a plurality of irradiation vectors for an apparatus for producing a three-dimensional work piece via additive manufacturing, according to an embodiment of the present disclosure.

The device 70 comprises a first defining module 72, configured to define a downskin region in a layer of a three-dimensional work piece 12. The device comprises a second defining module 74, configured to define a set of first irradiation vectors fully covering the downskin region 52, 54. At least one of the first irradiation vectors extends into a volume region 50 of the layer, adjacent to the downskin region 52, 54. The at least one of the first irradiation vectors have a length of 1 mm or more.

The device 70 comprises a third defining module 76, configured to define a set of second irradiation vectors, covering a remaining part of the volume region 50 of the layer. The device 70 comprises a first assigning module 78 configured to assign a first set of irradiation parameters to the set of first irradiation vectors. The device 70 comprises a second assigning module 80, configured to assign a second set of irradiation parameters to the set of second irradiation vectors, the second set of irradiation parameters being different from the first set.

Each of the modules 72 to 80 of the device 70 may be embodied in hardware and/or software. Further, not all of the modules are necessary located and/or operated at the same physical entity. For example, the device 70 may be a distributed cloud computing entity, wherein the individual modules are assigned to different physical servers. The device 70 may be configured to output an output file that can be read by the apparatus 10 in order to generate the three-dimensional work piece 12. The device 70 is configured to carry out the method described with regard to FIG. 3 above.

FIG. 5 shows a diagram including different embodiments how to define a plurality of irradiation vectors according to the present disclosure.

These embodiments may be regarded as more detailed descriptions of the method described with regard to FIG. 3. FIG. 5 shows different methods according to embodiments of the present disclosure.

The diagram of FIG. 5 stars with three specifications (pre-settings), 90, 92, and 94. According to specification 90, a threshold downskin angle is provided, as explained in more detail with regard to FIG. 2 above. The threshold downskin angle may be a numerical value (e.g., provided in degrees) and may be set by a user or loaded from a storage. The threshold downskin angle defines, at which angle a (slightly) inclined surface is no longer regarded as downskin surface, such that no downskin regions will be assigned adjacent to said surface. Further, specification 90 comprises a number of cover layers, dependent on a material used for the raw material powder and on the required quality of the work piece 12. The number of cover layers defines a number of layers, in which indirect downskin regions are provided on top of each other. Therefore, the number of cover layers corresponds to the predefined number discussed above with regard to FIG. 2, minus 1. The number of cover layers may be set by a user or may be loaded from a storage.

According to specification 92, a 3D-model of the work piece(s) 12 is provided. The 3D-model may be provided in the form of an input file, e.g., a CAD file. The 3D-model may comprise a model of support structures, alternatively, support structure geometries may be created previous to or during slicing.

Further, according to specification 94, a layer thickness is provided, which may depend on the used apparatus 10 and a required product quality. Instead of a fixed value for the layer thickness, an upper and/or lower boundary for these values may be set, wherein the slicer (see below) sets the individual layer thickness of each layer within these boundaries.

In a next step 96, a slicer generates the layers of the work piece(s) defined by the 3D-model. As a result, see step 98, a layer model is provided, wherein the slicer has already defined downskin (DS) areas 52, 54 and volume regions 50 in each layer, where appropriate. Alternatively, the definition of the downskin regions 52, 54 and volume regions 50 may be carried out by a separate module or entity and/or in a separate step.

In a next step 100, a hatcher 100 defines irradiation vectors for each of the layers of the work piece defined by the slicer.

The hatcher may operate according to different settings. A hatch rotation may be applied depending on a layer-based rule (step 102) and it may be decided (step 104) whether the hatch rotation shall be applied globally or regional. According to a first alternative, the hatch rotation is already predefined for the layers of the work piece 12. In other words, an orientation of the irradiation vectors within the layer (i.e., within the x-y-plane) is predefined. For example, the hatch rotation may have been set by the slicer 96 or in a subsequent step of the method. According to another alternative, the hatch rotation (i.e., an orientation of the irradiation vectors within the layer) is not predefined and may be freely chosen by the following methods. It should be noted that it can be the case that not all irradiation vectors are oriented along the same direction (i.e., parallel to each other), but, e.g., that different areas are defined in each layer, wherein an orientation of vectors in the different areas is parallel to each other but the orientations are rotated from area to area, e.g., by 90°. In this regard, a checkerboard pattern may be provided, wherein the areas are provided in square tiles. No matter which alternative is used, the hatch rotation may be restricted to certain orientations, e.g. depending on a direction of a gas flow.

The following parts of the method shown in FIG. 5 define the so-called hatching of the individual layers. The term hatching means that a position and/or orientation of the individual irradiation layers is defined for each layer. The irradiation vectors may be provided in groups of parallel vectors, e.g., stripes of parallel vectors or checkerboard tiles of parallel vectors.

In the context of different operation modes of a hatcher, three embodiments will be described, denoted as embodiment A, embodiment B, and embodiment C.

According to embodiment A, initial hatching is performed, e.g., in the form of stripes of parallel vectors or in the form of checkerboard tiles. In this initial hatching, the downskin regions 52, 54 are already considered, such that the downskin regions 52, 54 are hatched with different irradiation vectors than the volume regions. Subsequently, a rehatching is performed, wherein the initial hatching is adapted and downskin vectors are extended or otherwise defined to have a minimum length (e.g., 1 mm). Details of embodiment A will be described below.

According to embodiment B, an initial hatching is performed for the downskin vectors, wherein it is already taken into account that the downskin vectors shall have a minimum length (e.g., 1 mm). In a previous, simultaneous or following step, the volume vectors are hatched in the remaining part of the volume region. Details of embodiment B will be described below.

Embodiment C is similar to embodiment B and could also be seen as special case of embodiment B. According to embodiment C, an initial hatching is performed for the downskin vectors and the volume vectors, wherein it is already taken into account that the downskin vectors shall have a minimum length (e.g., 1 mm) and optionally the volume vectors having a same or different minimum length. All vectors are created due to preceding calculations already with optimum conditions, no following merging is necessary. Details of embodiment C will be described below.

Independent on which embodiment applied, in a first alternative, an individual hatch rotation may be chosen (e.g., independent from a hatch rotation of volume vectors) for each of one or more downskin regions. The orientation of the downskin vectors may be chosen such that no or as few as possible vectors below a minimum length (e.g., 1 mm) exist within the downskin region(s). In case such vectors should exist, they are extended to a length of at least the minimum length. These vectors can be extended either at a beginning side, an end side, or both sides of the vector.

According to a second alternative, a hatch rotation may be chosen for the downskin vectors, in a similar way as for the first alternative. However, the second alternative is under the prerequisite that a hatch rotation is not predefined by the layer. According to a third alternative, a global hatch rotation may be chosen for all downskin vectors (i.e., for all downskin vectors in all downskin regions 52, 54 of the respective layer). The hatch rotation may be chosen such that no or as few as possible downskin vectors have a length below a minimum length (e.g., 1 mm).

Since the first, second, and third alternatives are mainly directed to choosing an orientation of the downskin vectors, and no full hatching of the layer has to be performed, the hatching of the whole layer may be carried out analogous to embodiment A, analogous to embodiment B, or analogous to embodiment C. The detailed description of embodiments A, B, and C below applies mutatis mutandis to the embodiments in combination with one of the first, second, or third variants.

Further influences on the hatching may comprise work piece contours, scanning fields of one or more irradiation units, maximum vector lengths, etc. These prerequisites may have to be considered during hatching.

FIG. 6 shows details (i.e., the detailed method steps) of the embodiment A shown in FIG. 5.

Embodiment A starts with an initial operation [0], in which already a plurality of DS vectors and volume vectors are defined. The irradiation vectors of this initial definition may also be referred to as initial vectors. The method goes from vector to vector in a predefined order, e.g., in a predefined direction along the layer.

According to a first step [1], it is checked for the currently considered DS vector, whether its length has at least a length indicated herein as min. length. The min. length may have been set by the user and/or it may be a specification taken into account, similar to the specifications shown in FIG. 5 and discussed above. For example, the min. length may be set to 1 mm, 2 mm, 3 mm, 4 mm, or 5 mm, depending on the used material, the desired work piece quality, etc.

In case the vector has at least the desired min. length, there is no need to change it and the method continues to the next vector. In case the considered DS vector is too small (i.e., has a length smaller than min. length), it is checked to which sides merging is possible [2]. Therefore, a number of adjacent vectors or hatch fields (tiles) is determined (also referred to as candidate vectors or candidate hatch fields). Contour vectors may be considered as not existent. In this case, adjacent means along the direction of the vector, i.e., at a beginning side or end side of the vector. In particular, the adjacent vectors may be vectors having a same orientation and lying on an extension direction of the considered DS vector. In other words, the DS vector and the adjacent vectors can be merged to one vector having the direction of the DS vector.

In case the number of adjacent vectors is 0, there is no possibility to extend the DS vector under consideration and the method continues to the next vector. In case the number is 1, the DS vector is merged to a predefined target length. The predefined target length may be identical to the min. length, but it may also be larger. Here, merging to the target length means extending the DS vector into the direction of the candidate vector or candidate hatch field, such that it has the target length. The remaining part of the target vector or target hatch field remains unchanged. However, a small gap may be inserted between the extended vector and the remaining part.

Further, it is checked if initial and/or remaining volume vectors are sufficiently big and/or if initial and/or remaining volume tiles are sufficiently big [3]. When a DS vector is merged to a predefined target length, it is decided whether the remaining volume vector is long enough, i.e., has a length of at least min. length. In case of a candidate tile, it is decided whether the remaining tile is sufficiently big, i.e., has a size larger than a predefined value.

In case of yes, the method continues to the next vector. In case of no, it is decided whether there is an adjacent volume vector or hatch field, i.e., adjacent to the not sufficiently big volume vector or volume hatch field. In case of no, the not sufficiently long vector is merged to the DS vector. In case of a hatch field, the DS vector is extended such that it extends over the too small hatch field.

In case of yes, the not sufficiently long vector is merged to the adjacent vector or, in case of an adjacent hatch field, it is extended into the adjacent hatch field. Similar for a not sufficiently large hatch field. The method continues to the next vector.

In case merging to both sides is possible, i.e., a number of 2 adjacent vectors is determined (number of adjacent vectors or hatch fields), it is checked if merging to both sides or only one side is better [4]. Also it is determined if merging entire vectors or only part of them is better [5]. E.g., a number of adjacent too short volume vectors or too small tiles is determined. Again, the too short vectors are defined as having a length below a predefined value, e.g., min. length. The too small tiles are defined as having a size below a predefined threshold value.

In case the number is 2, the DS vector is merged to both (too short volume vectors or too small tiles) and continues to the next vector. In case the number is 1, the DS vector is merged to the one too short volume vector or too small tile. It is then checked whether the resulting DS vector is long enough, i.e., longer than min. length. If yes, the method continues to the next vector. In case of no, it is merged to the second one of the two adjacent vectors or hatch fields. It is then decided whether the remaining volume vector is long enough, i.e., at least min. length. If yes, it is continued to the next vector. In case of no, also the rest is merged and it is continued to the next vector.

In case the determined number of too short adjacent volume vectors is 0, an equal merge is calculated to both sides of the DS vector to the target length (e.g., min. length). Then, a number of remaining adjacent too short volume vectors or too small tiles is determined.

In case this number is 0, the calculated merge is maintained and the method continues to the next vector. In case the number is 1, the one vector becoming too small or becoming too small tile is merged completely. The other side leaves unmerged. The method continues to the next vector. In case the number is 2, it is decided whether the vector is within reach of x vectors (before/after) one-sided merged volume vector. In case of yes, it is merged to the same side and the other side leaves unmerged. The method continues to the next vector. In case of no, it is merged into a direction of the closer contour of the layer of the work piece. The other side leaves unmerged. In this step, however, a different rule is possible, since this choice is more or less arbitrary. The method then continues to the next vector.

After the above steps have been carried out for each DS vector, it may be checked again for too short volume vectors or too small tiles [6] and those may be merged to DS vectors to avoid too small vectors (i.e., smaller than min. length, so-called microvectors).

FIG. 7 shows the details (i.e., the detailed method steps) of the embodiments B and C shown in FIG. 5.

Embodiment B and C, both start from a situation, in which no initial DS vectors and volume vectors have been defined.

In embodiment B, according to a first step, a DS vector is created in the downskin region and it is checked whether the DS vector has been created at a position of a work piece contour (i.e., whether it starts and/or ends at a work piece contour) [1]. If this is the case, yes, the DS vector is created beginning from the work piece contour. Further it is determined for this vector whether its initial length is at least a predefined length, min. length. If yes, the next vector is created, e.g., adjacent to the first vector. If no, it is extended to a target length (e.g., equal to min. length) and then created [3]. If the vector is not located at a position of a work piece contour (no), it is determined whether a distance next to the DS vector (i.e., along an extension direction of the DS vector) to a work piece contour is below the min. length plus a difference of the min. length to the actual length of the DS vector [2].

If this is the case for both sides of the DS vector, the DS vector is extended from work piece contour to work piece contour. If this is the case for no side, the DS vector having its target length (e.g., min. length) is positioned central with regard to the DS. If this is the case for one side, it is checked whether the vector in DS has a length of at least the min. length. If yes, the DS vector is extended to the work piece contour then the next vector is created. If not, the vector is created with its target length beginning from the work piece contour.

In a previous, subsequent or simultaneous step, in particular after creating the DS vectors, the volume region is hatched with volume vectors [4]. If necessary, volume vectors are merged to DS vectors to avoid too small volume vectors (microvectors), i.e., vectors below min. length. When the volume region is hatched simultaneously, no merging may be necessary at all, this is shown in embodiment C.

In embodiment C, a similar method is applied as in embodiment B. However, instead of only checking positions, distances, and length in relation to the DS regions and vectors, all steps are also performed for volume regions and vectors. The last step of merging in embodiment B is dropped in embodiment C.

The following figures show some examples, how the technique for defining a plurality of irradiation vectors according to the present disclosure may be implemented for exemplary work piece layers and for different embodiments. It should be noted that the following figures illustrate certain features of the techniques described herein, which may lead to an improved or optimized definition of irradiation vectors for a particular layer. Although the following figures show methods of a definition of irradiation vectors how they could be carried out according to the technique described herein, it should be noted that the definition and assignment of the individual irradiation vectors is not necessarily optimized. In other words, further steps of shortening and/or further steps of extension of one or more of the irradiation vectors may be helpful in order to arrive at a further improved or even optimized definition of irradiation vectors.

FIG. 8 shows a scenario according to a case 1. A work piece area is shown, wherein a DS region 110 is provided at an edge region of the layer. The rest of the layer is defined as volume region 112. The upper part of FIG. 8 shows an initial hatching, wherein the DS region 110 is fully covered by DS vectors and the volume region 112 is fully covered by volume vectors. In both regions, a pattern of parallel hatch vectors with a same orientation is applied, wherein a hatch distance is the same and vector passes are aligned to each other. The lower part of FIG. 8 shows the same layer after a method according to the present disclosure has been applied. According to the method shown in FIG. 8, each of the DS vectors that has a length below a predefined length min. length, is extended to a next contour (more precisely: to a contour vector) of the work piece. In the example of FIG. 8, this is the case for all of the initial DS vectors. The contour adjacent to the downskin region (i.e. downskin contour) is also defined for irradiation with downskin parameters. In the example, the downskin contour is not merged with adjacent contour vectors. In another embodiment the downskin contour could also be merged extended with the contour vectors. In another embodiment all contour vectors and downskin contours are defined for irradiation with downskin parameters. In an alternative embodiment, the downskin contours are treated like normal contours, i.e. downskin contours are defined for irradiation with contour parameters.

FIG. 9 shows a scenario according to a case 2. In case 2, the upper part shows an initial hatching and the lower part has been transformed according to a method corresponding, e.g., to embodiment A discussed with regard to FIGS. 5 and 6 above. In the upper part, an inner DS region 110 is fully covered by DS vectors (dashed line) and a volume region 112 is fully covered with volume vectors (solid line). In the lower part, it is shown, firstly, that all of the initial DS vectors have been extended because they were below a min. length. The uppermost DS vector 114 is fully extended (above a target length) from contour to contour to an extended DS vector 114A, because otherwise, a remaining volume vector would have a length below min. length. The intermediate DS vectors 116 have been extended to a target length equally to both of its sides, to extended DS vectors 116A. In the lower region close to the contour of the work piece, two situations occur: At the left side, if the DS vector 118 would be extended equally on both sides, a remaining volume vector would have a length below min. length. The DS vector 118 therefore is extended until the contour is reached and extended to the target length by addition of the remaining portion from the volume vector at the other side, in other words the DS vector 118 is moved to the contour and an extended DS vector 118A results. Further, at the right side, the lowermost DS vector 120 is only extended to its right side to an extended vector 120A having the target length because at its left side, there is not enough space.

In this context, the following should be noted, which applies not only to the example of FIG. 9 but to all other examples and embodiments described herein. With regard to an irradiation of the individual irradiation vectors, different strategies are possible. For example, volume vectors and DS vectors can be sequentially irradiated. In particular, firstly, the volume vectors are irradiated and, subsequently, the downskin vectors (alternatively, vice versa). As an alternative, the volume vectors and downskin vectors may be irradiated in a “mixed” manner. For example, according to a stripe irradiation, the vectors may be irradiated in an order in which they are defined in the layer, wherein the irradiation parameters of the vectors change for DS vectors and volume vectors.

Further, according to the technique described herein (and not limited to any particular embodiment), a merging or definition of the vectors may consider an avoiding of “islands”, meaning tiles surrounded by vectors of another kind (e.g. DS-vectors) and/or regions not to be irradiated, or tiles being part of an irradiation stripe with previous and following tiles of another kind and/or regions not to be irradiated. In particular, this means that, preferentially, it is then merged such that former volume vectors are then irradiated with irradiation parameters of the DS vectors.

In the context of the scenario discussed above with regard to FIG. 9, considering a sequential irradiation of first volume vectors and then DS vectors, the two volume vectors of the upper left “corner” could be changed to downskin vectors in order to avoid a too small volume (or tile or island) in the upper left corner. In other words, these two volume vectors could be changed to DS vectors to be irradiated with DS irradiation parameters.

FIG. 10 shows a scenario according to case 2a, which shows a result of a transformation operation according to, for example, embodiment A or embodiment B discussed above. The example shows DS vectors 122 with sufficient length, which, therefore, have not been extended. Further, vectors 124A are shown which have been extended to one side only because an equal merging to both sides would have resulted in too short volume vectors at both sides.

FIG. 11 shows a scenario according to a case 3. It shows the result of a method, e.g., according to embodiment 1 discussed above. In the example, a hatching direction for the DS vectors (dashed line) has been chosen, which entirely avoids too short DS vectors, i.e., DS vectors with a length below min. length.

According to the technique discussed above, it may be possible, in at least some of the embodiments, to avoid or reduce a number of vectors below a predefined length (so-called microvectors), in the context of a presence of a downskin region. In this way, a quality of a produced work piece can be increased.

1-24. (canceled)

25. A method for defining a plurality of irradiation vectors for an apparatus for producing a three-dimensional work piece via additive manufacturing, the method comprising, for a layer of a three-dimensional work piece to be generated:
defining a downskin region in the layer;
defining a set of first irradiation vectors covering the downskin region, wherein at least one of the first irradiation vectors extends into a volume region of the layer, adjacent to the downskin region, the at least one of the first irradiation vectors having a length of 1 mm or more;
defining a set of second irradiation vectors covering a remaining part of the volume region of the layer;
assigning a first set of irradiation parameters to the set of first irradiation vectors; and
assigning a second set of irradiation parameters to the set of second irradiation vectors, the second set of irradiation parameters being different from the first set.

26. The method of claim 25,
wherein each of the first irradiation vectors has at least a length of 15 mm, 10 mm, 8 mm, 5 mm, 4 mm, 3 mm, 2 mm, or 1 mm; and/or
wherein each of the second irradiation vectors has at least a length of 15 mm, 10 mm, 8 mm, 5 mm, 4 mm, 3 mm, 2 mm, or 1 mm.

27. The method of claim 25,
wherein the downskin region is defined as a region of the layer in which fewer than a predefined number of work piece layers are provided between the layer and an underlying layer of unsolidified raw material powder; and/or
wherein the volume region is defined as a region of the layer in which at least the predefined number of work piece layers are provided between the layer and the underlying layer of unsolidified raw material powder or in which no underlying layer of unsolidified raw material powder exists; and/or
wherein the set of irradiation parameters comprise at least one of laser power, laser wavelength, scanning speed, scanning mode, laser spot size, laser spot shape, laser operation mode, hatch distance, and jump time between vectors.

28. The method of claim 25, further comprising:
defining one or more first initial vector(s) in the downskin region;
deciding, for each of the one or more first initial vector(s), whether the respective first initial irradiation vector has a length smaller than a first predefined length; and
for each of the one or more first initial vector(s), if it is decided that the first initial vector has a length smaller than the first predefined length, extending the first initial vector, such that it extends into the volume region, to form a first extended irradiation vector, wherein the at least one of the first irradiation vectors comprises the first extended irradiation vector.

29. The method of claim 25, further comprising:
defining a hatch pattern of initial vectors for the downskin region and for the volume region, wherein the downskin region is covered by a set of first initial vectors and the volume region is covered by a set of second initial vectors;
deciding, for a plurality of the first irradiation vectors, whether the respective first initial vector has a length smaller than a first predefined length; and
for each of the plurality of first initial vectors, if it is decided that the first initial vector has a length smaller than the first predefined length, extending the first initial vector, such that it extends into the volume region, to form a first extended irradiation vector, wherein the at least one of the first irradiation vectors comprises the first extended irradiation vector.

30. The method of claim 29,
wherein at least one of the second initial vectors in a region adjacent to the downskin region has an orientation different from an orientation of the first extended irradiation vector, and wherein the at least one of the second initial vectors is at least partially discarded and a discarded part of said second initial vector is replaced by the first extended irradiation vector; and/or
wherein the step of extending comprises merging the first initial vector with one or two adjacent second initial vector(s) to form the first extended irradiation vector.

31. The method of claim 30, wherein the first extended irradiation vector has the first predefined length.

32. The method of claim 30,
wherein, in the step of merging, the first initial vector is merged with two adjacent second initial vectors, such that a merged section of a first one of the adjacent second initial vectors has a same length as a merged section of a second one of the adjacent second initial vectors; and/or
wherein an entire adjacent second initial vector is merged with the first initial vector, in particular the second initial vector being adjacent to a contour vector on its other end before merging.

33. The method of claim 32, further comprising:
after the step of merging, deciding whether a remaining portion of at least one of the one or two adjacent second initial vector(s) is smaller than a second predefined length; and
if it is decided that the remaining portion is smaller than the second predefined length, merging the first merged irradiation vector with the remaining portion to form a second extended irradiation vector, wherein the at least one of the first irradiation vectors comprises the second extended irradiation vector.

34. The method of claim 30, further comprising:
identifying second initial vectors having a length smaller than the second predefined length; and
merging the identified second initial vectors to adjacent first initial vectors or adjacent first or second extended irradiation vectors to form a first irradiation vector.

35. The method of claim 25, further comprising:
defining a set of first initial vectors, wherein a plurality of the first initial vectors are extending into a volume region of the layer and have a same first predefined length, each of the plurality of first irradiation vectors comprising a corresponding first initial vector; and
defining a set of second initial vectors, in particular after the step of defining the set of first initial vectors, wherein at least some of the second irradiation vectors correspond to a corresponding second initial vector.

36. The method of claim 35, further comprising:
identifying second initial vectors having a length smaller than a second predefined length; and
merging the identified second initial vectors to adjacent first initial vectors to form a first irradiation vector.

37. The method of claim 35, further comprising:
identifying a work piece contour in a distance to a border of a downskin region smaller than a second predefined length; and
defining a first initial vector extending to the work piece contour.

38. The method of claim 25, further comprising:
determining an orientation of the set of first irradiation vectors within the layer, such that an amount of sections of the first irradiation vectors is minimized, wherein the sections are defined as being within the downskin region and having a length smaller than a first predefined length.

39. The method of claim 29, further comprising:
determining an orientation of the set of first initial vectors within the layer, such that an amount of sections of the first initial vectors is minimized, wherein the sections are defined as being within the downskin region and having a length smaller than a first predefined length.

40. The method of claim 25, further comprising:
irradiating the layer of the three-dimensional work piece according to the defined set of first irradiation vectors and the defined set of second irradiation vectors.

41. A computer program product comprising program code portions for performing the method as claimed in claim 25 when the computer program product is executed on one or more computing devices.

42. The computer program product of claim 41, stored on a computer-readable recording medium.

43. A device for defining a plurality of irradiation vectors for an apparatus for producing a three-dimensional work piece via additive manufacturing, the device being configured to, for a layer of a three-dimensional work piece to be generated:
define a downskin region in the layer;
define a set of first irradiation vectors covering the downskin region, wherein at least one of the first irradiation vectors extends into a volume region of the layer, adjacent to the downskin region, the at least one of the first irradiation vectors having a length of 1 mm or more;
define a set of second irradiation vectors covering a remaining part of the volume region of the layer;
assign a first set of irradiation parameters to the set of first irradiation vectors; and
assign a second set of irradiation parameters to the set of second irradiation vectors, the second set of irradiation parameters being different from the first set.

44. The device of claim 43, further configured to carry out the steps of claim 25.
